(19) United States
(12) Patent Application Publication
(10) Pub. No.: US 2007/0291791 A1
(43) Pub. Date: Dec. 20, 2007

(54) Dynamic reconfigurable embedded compression common operating environment

(75) Inventors: Kent L. English, Harvester, MO (US); Jeffrey G. King, O'Fallon, MO (US); Thomas G. King, O'Fallon, MO (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company.

(21) Appl. No.: 11/454,461

(22) Filed: Jun. 16, 2006

(51) Int. Cl. H04J 3/16

(52) U.S. Cl. 370/469; 370/252

(57) ABSTRACT

Dynamically reconfigurable middleware is embedded in hardware form in communication network platforms to implement network security policies, exploit data and increase data throughput, especially in mobile ad hoc environments. The hardware includes a quality of service manager for receiving data from the network and prioritizing the data according to predetermined classes of data service. An embedded security manager authenticates data received from the network based on a predetermined security policy and allows only that data to reach applications running on the platform that has been authenticated. A data exploitation manager detects receipt at the platform of predetermined types of data of interest to the platform. Routing tables are provided for determining the routing of the data to a destination, and a protocol engine is employed to specify the protocol to be used in routing the data.

### FIELD OF THE INVENTION

This invention generally relates to data communication networks, particularly in mobile, ad hoc environments, and deals more particularly with dynamically reconfigurable, embedded platform hardware for improving network performance and quality.

### BACKGROUND OF THE INVENTION

Data communication systems comprising networked platforms running distributed software applications benefit from improvements that increase throughput while maintaining quality-of-service (QoS). It is particularly important to optimize network usage for platforms in a network centric (Net-Centric) environment, as well as to increase platform capabilities by eliminating soft-state problems inherent in mobile, ad hoc environments. Net-Centric operations are utilized by the military, for example, for exploiting state-of-the-art information and networking technology to integrate widely dispersed human decision makers, sensors, forces and weapons into a highly adaptive, comprehensive system in order to improve mission effectiveness. In Net-Centric environments, there is a cost associated with building up and tearing down network “sessions” when nodes enter and leave a mobile, ad hoc network. These costly sessions affect network performance as well as the QoS for time critical information, since “state” information is traditionally stored at network nodes along the path for any established session in the network.

Rigid state machines that utilize transmission protocols similar to the TCP (Transmission Control Protocol) are particularly prone to failure in mobile communication environments due to the unreliability of the communication links and overhead incurred from having to rebuild the communication path or “sessions”. Thus, it is normally preferred to implement mobile communications with “soft state” machines which tend to be fault resilient.

Distributed software applications are currently developed that have common middleware solutions such as Common Object Request Broker Architecture (CORBA), Remote Method Invocation (RMI), Simple Object Access Protocol (SOAP) or Data Distribution Service (DDS) to facilitate data interoperability. Java Virtual Machines (JVM) provide operating system independence, allowing the application to run on various operating systems, however JVM operates from a memory and therefore is limited in its performance.

The ability to exploit data within a network is also an area that is subject to improvement. As the amount of information that traverses a network increases, it becomes more important to address the data “mining” capabilities that are available within the network. Data mining refers to the analysis of large sets of data to establish relationships and identify patterns. Normally, applications are required to wait for data to be pulled off the network stack and then analyzed to determine whether it is the correct data for its analysis. If the data is incorrect and the application is required to wait for a new set of data or query for a resend, unnecessary latency, i.e. delay, is introduced into the software processing.

Existing networks can also benefit from improved techniques for implementing data security. For example, authentication, authorization and accounting (AAA) functions currently require manual entry on a platform that authenticates access management from a server elsewhere in the network. This results in the data received at a platform having the potential to reach application software before it is authenticated. Moreover, precious time is spent in communicating with the platform that authenticates the data.

Accordingly, there is a need in the art for a system that optimizes network usage, increases throughput while providing higher levels of security and enhances data mining capabilities. The present invention is intended to satisfy this need.

### SUMMARY OF THE INVENTION

According to one aspect of the invention, network platform interface hardware is provided, comprising: a quality of service manager for receiving data from the network and prioritizing the received data according to predetermined classes of data service; a security manager for authenticating data received from the network based on a predetermined security policy and allowing only that data to pass through the platform that has been authenticated; and, a data exploitation manager for detecting receipt at the platform of predetermined types of data of interest to the platform. Routing tables are coupled with the quality of service manager for determining the routing of the data to a destination, and a protocol engine is provided for specifying the protocol to be used in routing the data. An interface description language (IDL) engine is provided to enforce the data marshalling/demarshalling process. The security manager includes stored access control lists. An XML parser is coupled with the data exploitation manager for parsing data received in XML format.

According to another aspect of the invention, data processing hardware is provided at each at each of the platforms defining nodes in a data communication network running distributed software. The data processing hardware comprises a security manager for authenticating data received at the platform from the network based on a predetermined security policy and allowing only that data to pass through to the application software platform that has been authenticated. A quality of service manager may also be provided for receiving data from the network and prioritizing the received data according to predetermined classes of data service. A data exploitation manager detects receipt at the platform of predetermined types of data of interest to the platform. The security manager, the quality of service manager and the data exploitation manager are preferably embedded in a programmable device, such as a field programmable gate array (FPGA).

According to still another aspect of the invention, a method is provided for processing data received at a hardware platform forming a node in a data communication network. The method comprises the steps of: receiving data at the platform from the network; authenticating the data based on a predetermined security policy; detecting receipt at the platform of predetermined types of data; and, passing only that data to a software application running on the platform that has been authenticated and detected. The authentication and detection are preferably performed in a programmable hardware device such as a field programmable gate array.

An important feature of the invention resides in the use of hardware to implement middleware solutions, using programmable devices such as Field Programmable Gate Arrays (FPGA). By embedding middleware solutions in hardware resident at each network node, data throughput is increased, data mining capabilities are enhanced and security policies can be implemented that improve validation and integrity.

Various additional objects, features and advantages of the present invention can be more fully appreciated with reference to the detailed description and accompanying drawings that follow.

### BRIEF DESCRIPTION OF THE DRAWINGS

FIG. 1 is a broad block diagram showing the component parts of a platform forming a node in a communication network using the present invention.

FIG. 2 is a view similar to FIG. 1 but showing data flow between two nodes forming part of the network.

FIG. 3 is a block diagram showing the major components of a mother board forming part of a platform in the network shown in FIG. 2.

FIG. 4 is a block diagram showing the layering of hardware and software components in a network platform employing the present invention.

FIG. 5 is a block diagram showing a network interface card used in a network platform incorporating the system of the present invention.

FIG. 6 is a block diagram showing details of the quality of service manager forming part of the network interface card shown in FIG. 5.

FIG. 7 is a flow diagram showing the processing of data received at a platform from the network.

FIG. 8 is a flow diagram showing the flow of data from a platform to the network.

FIG. 9 is a flow diagram showing how security checks are performed on data received from the network.

### DETAILED DESCRIPTION OF THE PREFERRED EMBODIMENTS

The present invention provides multiple advances in network performance by integrating network, database and middleware technologies. Broadly, the present invention incorporates a variety of middleware solutions into adaptable hardware, such as a Field Programmable Gate Array (FPGA), that provides superior performance in embedded systems. The use of hardware such as FPGA to implement middleware solutions, permits parallel processing of data, allowing real-time performance for middleware elements. Multiple embedded middleware strategies are realized in FPGA's to allow for data interoperability between distributed applications running on multiple platforms. Examples of middleware solutions that can be incorporated into the FPGA of the present invention include Common Object Request Broker Architecture (CORBA), Remote Method Invocation (RMI), Simple Object Access Protocol (SOAP), and Data Distribution Service (DDS), by way of example.

Java Virtual Machines (JVM) are also implemented in the FPGA of the present invention in order to provide operating system independence, allowing applications to run on various operating systems. By integrating multiple embedded middleware strategies into the hardware solution of the present invention, applications take advantage of simultaneous middleware solutions without having to rework old application framework to accommodate new middleware solutions. Platforms utilizing the hardware of the present invention will experience reduced software processing overhead, while gaining a variety of capabilities, such as dynamic platform perimeter security, network security, pluggable embedded middleware, QoS and enhanced data exploitation. Using the FPGA hardware of the present invention, data can be read at a platform virtually at data line speed, thereby maximizing system throughput.

As will be discussed below in more detail, the system of the present invention integrates security policies in hardware form so that when data is captured and analyzed at a platform, it can be discarded if it does not conform to the security policies, before it is passed to the application or have an opportunity to run malicious software. By embedding security in the hardware, it is possible to authenticate other systems in the network to which the platform is connected.

Middleware is generally defined as software that functions as a conversion or translation layer, although it may also perform consolidation and integration functions. Middleware solutions have typically functioned to enable one application to communicate with another that ether runs on a different platform or is provided by a different vender, or both. Middleware is most often used to support complex, distributed applications, and in a distributed computing system, middleware comprises the software layer that lies between the operating system and the applications on each platform in the system.

In addition to increasing throughput and providing security at the platform-network interface, the hardware solution of the present invention reduces latency and increases a platform's ability to exploit data. Thus, by integrating middleware solutions into hardware at each platform, the platform may extract particular information of interest to it that is traveling through the network, and the platform can be assured that critical data intended only for its receipt is not shared with other platforms in the network.

The integration of middleware solutions into the hardware of the present invention improves QoS, particularly in mobile communication environments, because hardware-embedded security policies shared by each platform in the network provides a means of detecting the loss of a node, and overcoming this loss by relying on the embedded security at other nodes. When a node is lost, it can reconfigure itself by communicating with other nodes that share the same security policies, and retrieve these policies from other authorized network entities during the reconfiguration process.

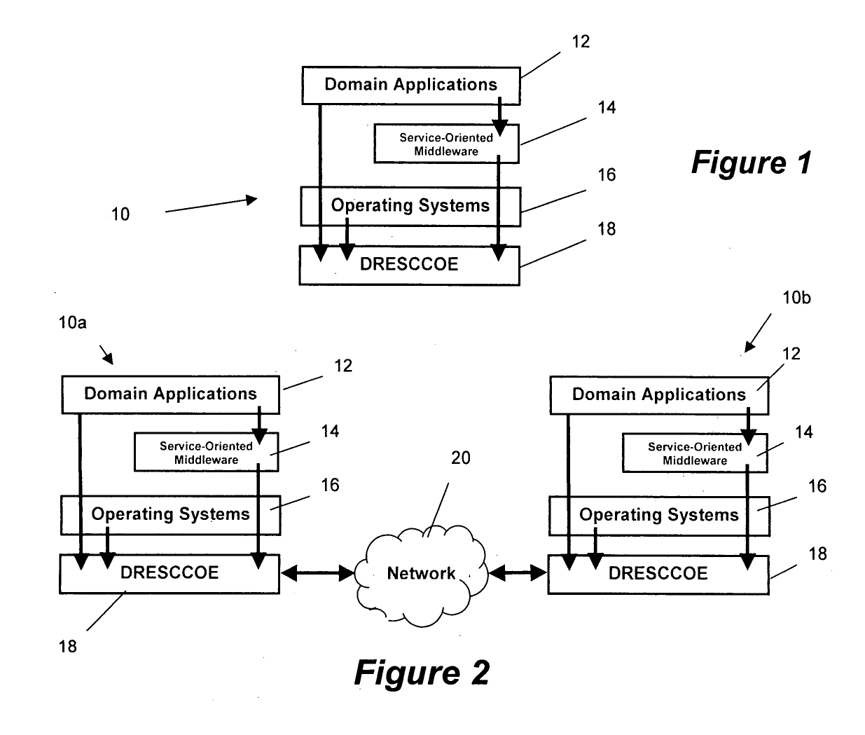

Attention is now directed to FIG. 1 which shows, at a high level, the relationship between the hardware of the present invention and other components running on a platform 10 at a network node or site. The platform 10 shown in FIG. 1 is a compressed operating environment which broadly comprises domain applications 12, Service-Oriented Middleware (SOM) 14, operating systems 16 and a Dynamic Reconfigurable Embedded System Compression Common Operating Environment 18 (DRESCCOE 18). DRESCCOE 18 effectively acts as a hardware interface with a network to which the platform 10 is connected. As indicated by the arrows showing data flow in FIG. 1, the applications 12 may transfer data to DRESCCOE 18 either directly, or through SOM 14 which comprises traditional middleware software. In accordance with the present invention, however, throughput of data is substantially increased as a result of the domain applications 12 being able to communicate directly with DRESCCOE 18. In some cases the applications 12 may communicate directly to DRESCCOE 18, while in other cases certain components of the operating systems 16 may be required to facilitate these communications.

FIG. 2 shows a pair of platforms, 10a, 10b each of which is connected to a network 20 via an associated DRESCCOE 18. As previously mentioned, DRESCCOE 18 incorporates embedded security polices which scan line data received from the network 20 and perform a number of functions on this data, as will be discussed later in more detail.

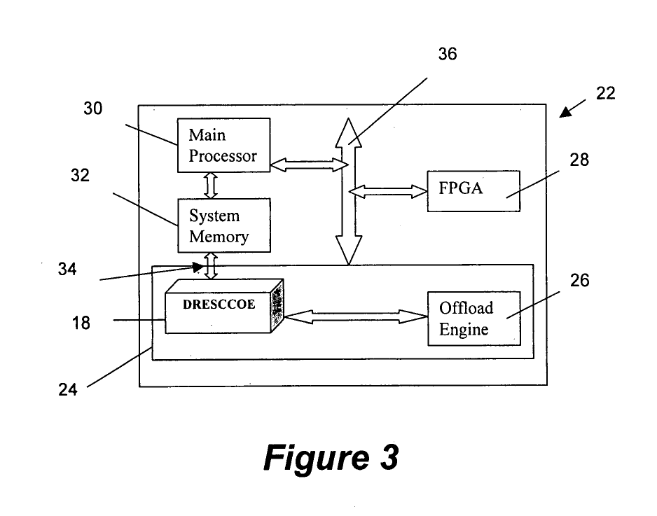

FIG. 3 shows the basic hardware components on a motherboard 22 at a platform site employing the system of the present invention. DRESCCOE 18 communicates directly with a TCP offload engine 26 which is in turn connected to the network 20. DRESCCOE 18 and the offload engine 26 are typically embedded as circuits in a network interface card (NIC) 24, with DRESCCOE being implemented in an FPGA. DRESCCOE 18 is connected by a memory bus 34 to system memory 32 which in turn is controlled by a main processor 30. Another FPGA 28 for performing system logic functions, along with a main processor 30 are connected to the NIC 24 by a system bus 36. The offload engine 26 is a standard device that handles connection and disconnection of the network platform 10 to the network 20 and uses various techniques such as handshakes, check sums, sliding window calculations, etc. for managing connections to the network 20 using TCP. Thus, from the architecture shown in FIG. 3, it may be appreciated that DRESCCOE 18 controls data received from and transferred to the network 20 via the offload engine 26.

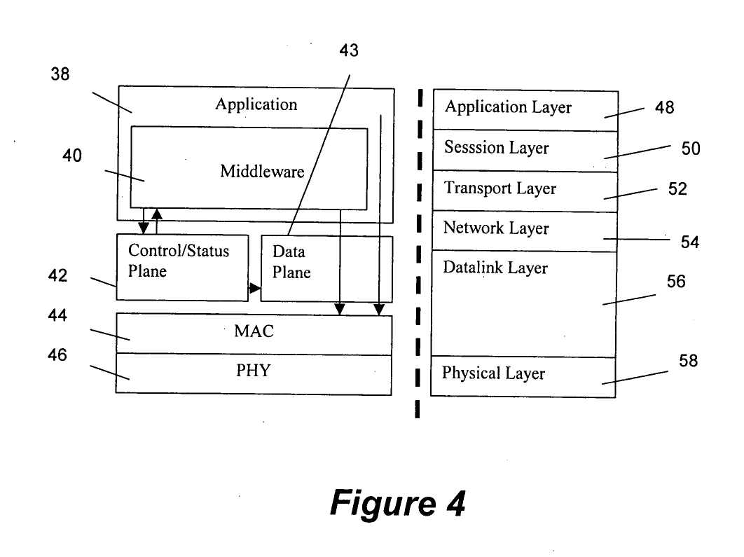

Referring also now to FIG. 4, several layers of the OSI (Open System Interconnection) are shown on the right of the Figure. These layers include, from top to bottom, the application layer 48, session layer 50, transport layer 52, network layer 54, datalink layer 56 and physical layer 58. The layers 48-58 are shown separated by a dotted line from an architectural layout of the hardware and software running on a platform in which the elements roughly correspond to the hierarchy of the layers 48-58. As can be seen on the left side of FIG. 4, application software 38 and middleware 40 roughly correspond to the application, session and transport layers 48-52 on the platform.

The control/status plane 42 and data plane 43 interface with the middleware 40 and roughly comprise the network layer 54 and the datalink layer 56. The application software 38 and middleware 40 also interface with the media access control 44 (MAC), and the physical components 46 (PHY), which roughly correspond to the datalink layer 56 and the physical layer 58 of the OSI reference model. FIG. 4 demonstrates how the application 38 containing the middleware 40 is the area where the operating system and device drivers interact with each other in the hardware. FIG. 4 also demonstrates that the middleware 40 corresponds to the session and transport layers 50-52 respectively in the OSI reference model.

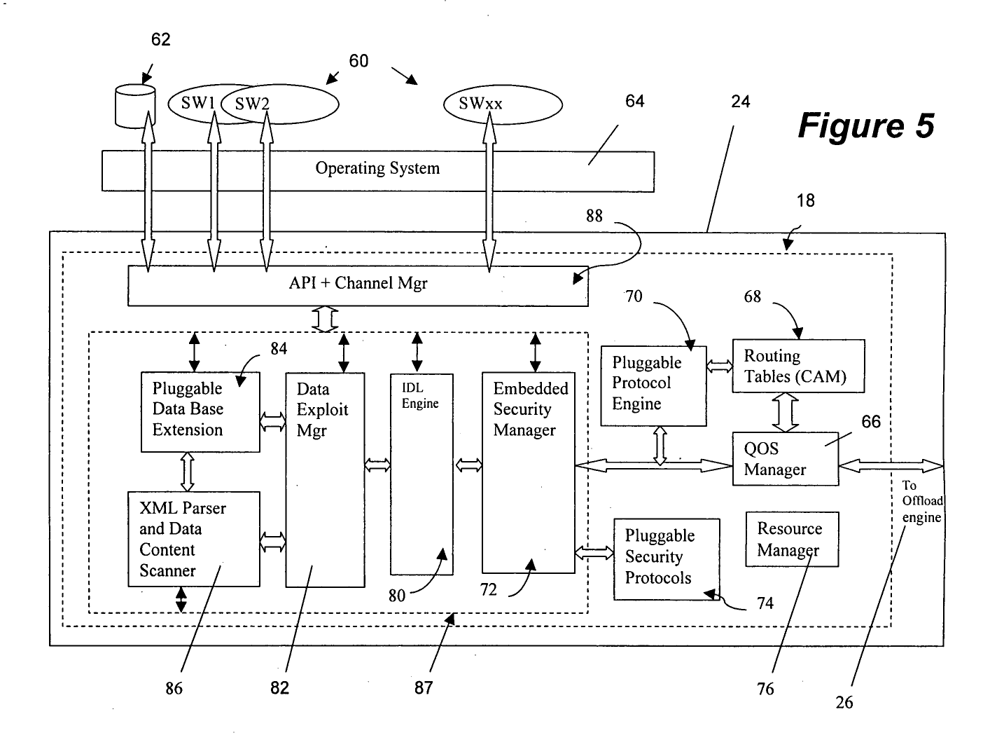

Referring now to FIG. 5, DRESCCOE 18 is shown as forming part of the NIC 24 which may include various other components, including the offload engine 26. DRESCCOE 18 may be in the form of a FPGA as previously discussed. The network interface card 24 transfers data between the network and software applications 60 as well as database applications 62, under control of an operating system 64. Data coming off of the network is processed by the offload engine 26 and passed to a QoS manager 66 which may route the data either directly to an embedded security manager (ESM) 72 or indirectly, using a set of routing tables 68 and a pluggable protocol engine 70. A resource manager 76 monitors the overall health of the FPGA and provides data back to a higher level maintenance program (not shown running outside of the FPGA.

Pluggable security protocols 74 are connected to the ESM 72 and comprise pluggable IP cores forming a circuit used for security purposes. The routing tables 68 may be stored in content addressable memory (CAM) such as a flash memory, and comprise any of multiple routing protocols used in corresponding, differing networks. A routing table is a set of rules, often viewed in table format, that is used to determine where data will be directed. The pluggable protocol engine 70 may comprise, for example, routing protocols such as OSPF, RIP, etc, or routed protocols such as IP, TCP, etc. Generally, routing protocols are formulas, or protocols, used by a router to determine the appropriate path over which data is transmitted. The routing protocol also specifies how routers in a network share information with each other and report changes. The routing protocol enables a network to make dynamic adjustments to its conditions, so that routing decisions do not have to be predetermined and static. In the illustrated embodiment, the pluggable security protocols 74 comprise a list of protocols governing data access control, which are embedded in a circuit forming part of the FPGA.

The resource manager 76 comprises an overall chain resource manager for the FPGA, and functions to detect problems that may occur in the middleware 40 or with routing protocols. If such problems are detected, the resource manager 76 automatically signals to the user, application or a mission computer, that it has detected a problem so that trouble shooting routines can be run, or data can be recorded to enable later analysis and solution of the problem. In other words, the resource manager 76 monitors the overall health of the FPGA and provides data back to higher level maintenance programs running outside of the FPGA.

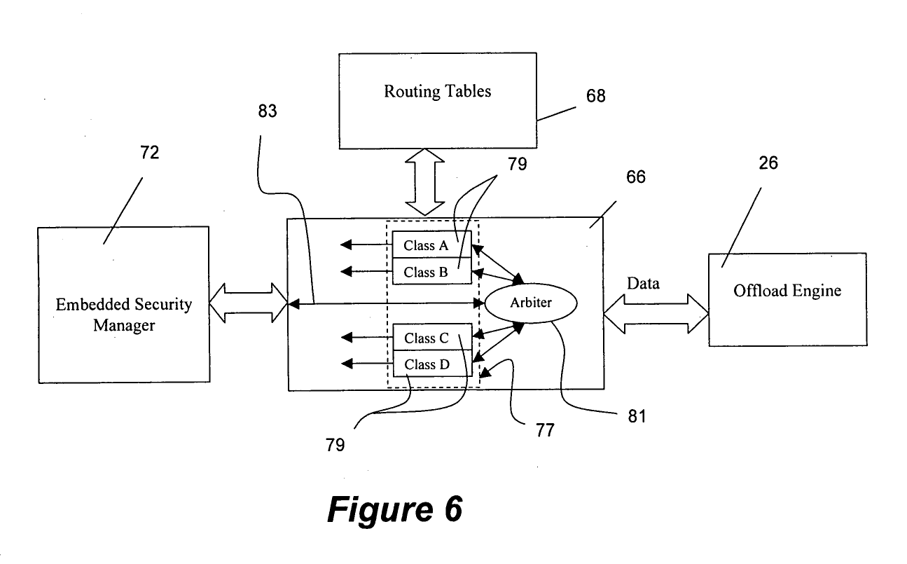

Referring now simultaneously to FIGS. 5 and 6, the QoS manager 66 functions to implement any of several predetermined “classes of data service” 77, such as classes A-D 79, which respectively represent differing levels of data service quality. The QoS manager 66 operates in concert with the routing tables 68 and pluggable protocol engine 70 in a manner to prioritize the incoming data from the network according to the different classes of data service that are specified in a frame comprising a header and footer bracketing a data packet. “Class of data service” is a queuing discipline in which an algorithm compares fields of packets or class of service tags to classify packets and to assign the data to queues of differing priority.

The QoS is specified in the form of network statements that are appended to data from remote locations and interpreted by the QoS manager 66 as a request to prioritize the incoming data so as to provide the specified level of class of data service. An arbiter 81 scans the QoS bits in the frame of the incoming data packet, and prioritizes the data according to the individual classes 79. Accordingly, data identified by the arbiter 81 as being “Class A” 79 is passed through first, and data identified as “Class D” 79 is passed through last. In the event that a QoS is not specified in a frame, then the incoming data is transmitted through a general path 83 directly to the ESM 72 for processing. Software applications 60 that are registered for a particular class of data service 79 will have priority in receiving or servicing data. It should be noted here that while the QoS manager 66 contributes significantly to the benefits of the present invention, it need not be employed in the simplest form of the invention.

The ESM 72 is updated from the local platform 10 and performs functions related to authentication, authorization and accounting. The ESM 72 authenticates data entering the platform from the network and authorizes the authenticated data to enter the system. The ESM 72 also maintains a record of unauthorized attempts to gain access to the system platform. “Accounting” refers to the ability of the ESM 72 to keep track of incoming data, and particularly unauthorized attempts to gain access to the system. In effect, the ESM 72 determines whether a security policy has been specified, and if so, whether it is enforced. The security policies may be contained in the software applications 60 or stored in a circuit containing the ESM 72. The ESM 72 functions to verify that the incoming data conforms to the specified security policies, and only that data that satisfies the security policies is allowed to enter the platform. If the incoming data does not conform to the specified security policies, the data is simply dropped and is not allowed to reach the applications 60. Thus, it can be appreciated that incoming data that is not authorized or does not conform with specified security policies need not be evaluated by the applications 60, thus reducing the data processing overhead on the applications 60. In effect, the ESM 72 acts as a client to corresponding embedded security managers at platforms in other nodes in the network.

Assuming that the security policy has been satisfied by the data, the data is passed through the ESM 72 to the IDL engine 80 which carries out functions normally allocated to middleware such as changing the form of the presentation of the data and marshalling/demarshalling services, or ORB (Object Request Broker) services for CORBA and DDS. In some cases, the software applications 60 may not require middleware, in which case the data will pass directly to the applications 60 or to the data exploitation manager 82. The IDL engine 80 provides computer language or simple syntax for describing the interface of a software component. It is essentially a common language for writing a “manual” on how to use a piece of software from another piece of software, in much the same way that a user manual describes how to use a piece of software to the user. IDLs are used in situations where the software on either side may not share common “call semantics”, referring to the way the computer language “talks” to the routines. For instance, “C” and Pascal languages have different ways of calling routines, and in general cannot call code written in the other language. IDLs are a subset of both, a general language to which both can conform to enable language-independent code. In the illustrated embodiment, the IDL engine 80 can dynamically update interfaces for messages that are expected on the interface; or that additional interfaces can be managed for multiple messages as they are identified in the data stream. The IDL engine 80 can handle multiple marshallers/demarshallers and can be flashed on the fly to account for enforced data policies on the platform 10, or if the IDL contract is flawed, then it can be updated on the fly

After processing by the IDL engine 80, the data is delivered to the data exploitation manager 82 which functions to detect predetermined types of data that are expected to be received in the incoming data stream, and passes this detected data directly to the applications 60. The data exploitation manager 82 cooperates with a pluggable database extension 84. The pluggable database extension 84 stores pre-selected elements from other databases in the network, so that these database elements can be extracted, as desired, to populate databases controlled by the database applications 62.

A real time XML parser and data content scanner 86 is provided which operates in concert with the pluggable database extension 84 and the data exploitation manager 82. The XML parser and data content scanner 86 provides, in embedded hardware form, a means of reading XML files and making the information from those files available to applications and programming languages. Thus, XML parsing is performed at the hardware level, rather than at the software level, in order to reduce latency of the system.

It should be noted here that the incoming data stream from the QoS manager 66 may pass through and be processed by any of the processing elements 72, 82 or 84, depending upon selected protocols, options and application requirements, however any of this data may pass directly from elements 72, 82, 84 to the applications 60 through an API/channel manager 88. Thus, elements 72, 80, 82, 84 and 86 are depicted in FIG. 5 as a group within a virtual dotted line boundary 87 to indicate that each of these elements can interface with the API/Channel manager 88. The API (Application Program Interface)/channel manager 88 manages multiple applications channels, or Service Access Ports (SAP), in the illustrated example. Application “channels” are registered with the database extension 84, the XML parser 86 and data content scanner, the data exploitation manager 82 and the ESM 72. The API/channel manager 88 is essentially a plug-in hardware item that facilitates the development of applications.

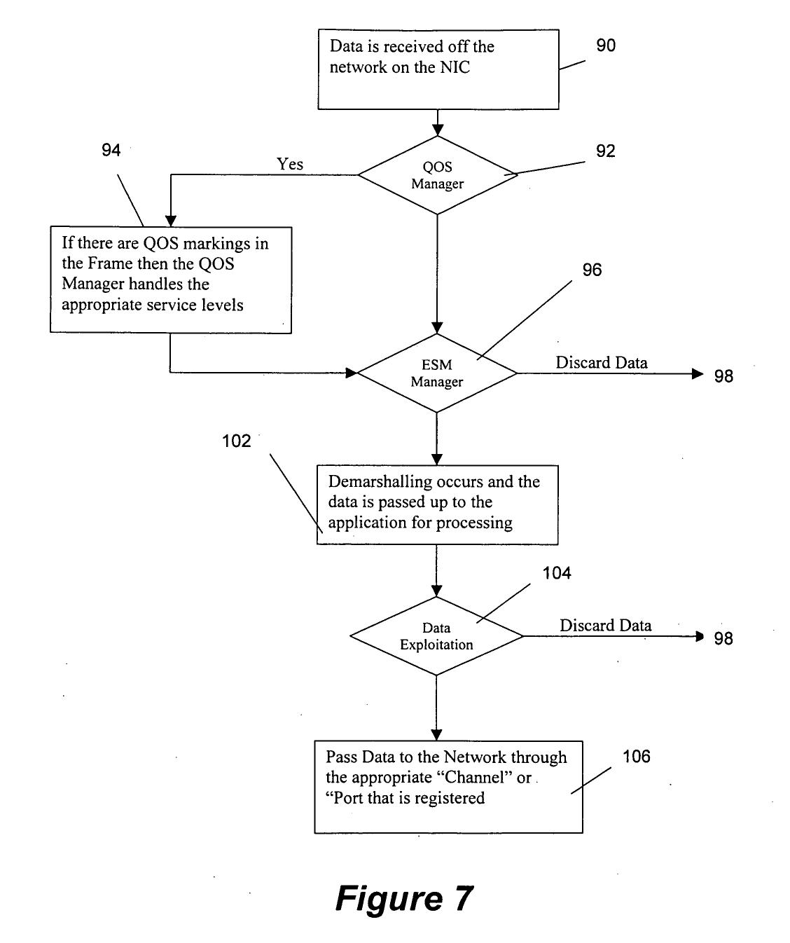

FIG. 7 is a flow diagram showing the steps in processing the data received from the network and initially processed by the offload engine 26 (FIG. 5). First, the data is received from the network into the network interface card (NIC) 24, at step 90. Next, the data is processed by the QoS manager 66 at step 92. If the frame containing the data possesses QoS markings, then the QoS manager 66 will impose the appropriate quality of data service as indicated at step 94, otherwise the data will be passed directly to the embedded security manager 72 at step 96. If the data cannot be authenticated, it will be discarded at 98, otherwise, if appropriate, the data will be demarshalled by the IDL engine 80 at step 102 and passed to an application 60 for processing. Otherwise, the data will be sent to the exploitation manager 82, at step 104. If the incoming data received by the exploitation manager 82 at step 104 is not data that is of interest to the platform, it is discarded at 98. However, if the data is of interest, it is passed on to the applications 60 through the API/channel manager 88, as shown at step 106.

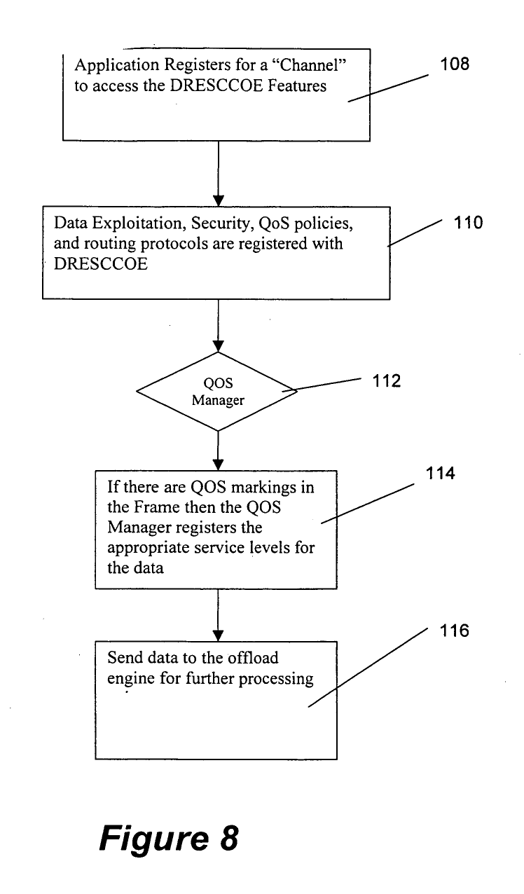

FIG. 8 shows the steps related to the flow of data from the platform out to the network. First, the applications 60 register for a “channel” at step 108, in order to access the features of the DRESCCOE 18. Essentially, these features include the security policy manager, the middleware, data exploitation features and QoS features, which are registered with DRESCCOE at 110. Next, the data is processed by the QoS manager 66 at step 112. At step 114, if QoS markings are found in the frame, then the QoS manager 66 registers the appropriate service levels for the data, and the data is then sent to the offload engine 26 for further processing as indicated at step 116.

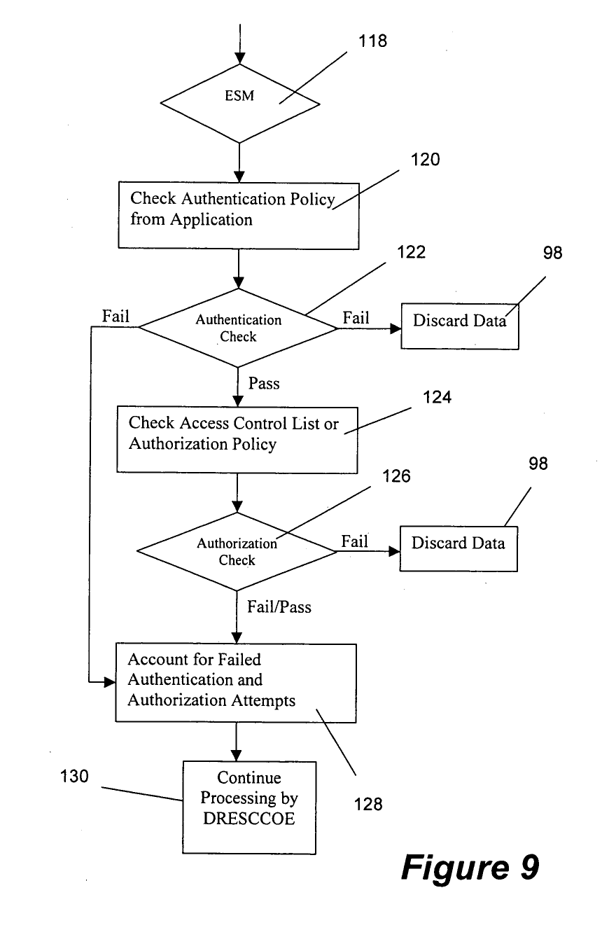

FIG. 9 shows in more detail the processing of incoming data for security. Data received by the ESM 72 at step 118 is first processed according to the pre-programmed authentication policy at 120. The authentication check is made at 120, and if the data fails to meet the security policies i.e. fails authentication, the data is discarded at 98, and a record is made at 128 to account for the failed authentication and related attempts. If the data is authenticated, however, then a further check is made at 124 to determine whether the data is authorized and confirm that the destination of the received data is valid. If the data is not authorized, it is discarded at 98, and the failure is logged at 128. After the authorization check is performed at 126, all authorized, authenticated data continues for further processing by other features of DRESCCOE 18 at step 130.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Further, while advantages associated with certain embodiments of the invention have been described in the context of those embodiments, other embodiments may also exhibit such advantages, and no embodiment need necessarily exhibit such advantages to fall within the scope of the invention. Accordingly, the invention is not limited, except as by the appended claims.

What is claimed is:

1. Network platform interface hardware, comprising:
a quality of service manager for receiving data from the network and prioritizing the received data according to predetermined classes of data service;
a security manager for authenticating data received from the network based on a predetermined security policy and allowing only that data to pass through the platform that has been authenticated; and,
a data exploitation manager for detecting receipt at the platform of predetermined types of data of interest to the platform.

2. The network platform interface hardware of claim 1, further comprising:
routing tables coupled with the quality of service manager for determining the routing of the data to a destination; and
a protocol engine coupled with the routing tables for specifying the protocol to be used in routing the data.

3. The network platform interface hardware of claim 1 further comprising an interface description language engine coupled with the security manager for changing the form of the presentation of the data authenticated by the security manager.

4. The network platform interface hardware of claim 1, further comprising a memory for storing a table of rules used to determine routing of the data at the platform.

5. The network platform interface hardware of claim 1, further comprising a circuit coupled with the security manager and containing security protocols governing access of data to the platform.

6. The network platform interface hardware of claim 1, further comprising an XML parser coupled with the data exploitation manager for parsing data received in XML format.

7. The network platform interface hardware of claim 1, further comprising:
a software application program for performing operations using the data received at platform from the network; and
an application programming interface connected between the software application program and the combination of the quality of service manager, the security manager and the data exploitation manager.

8. The network platform interface hardware of claim 1, wherein the quality of service manager, the security manager and the data exploitation manager are embedded in a field programmable gate array.

9. In a data communication network running distributed software over platforms defining nodes in the network, data processing hardware at each of the platforms, comprising:
a security manager for authenticating data received at the platform from the network based on a predetermined security policy and allowing only that data to pass through to the application software platform that has been authenticated.

10. The data processing hardware of claim 9, further comprising a quality of service manager for receiving data from the network and prioritizing the received data according to predetermined classes of data service.

11. The data processing hardware of claim 9, further comprising a data exploitation manager for detecting receipt at the platform of predetermined types of data of interest to the platform.

12. The data processing hardware of claim 11, further comprising a quality of service manager for receiving data from the network and prioritizing the received data according to predetermined classes of data service.

13. The data processing hardware of claim 12, wherein the security manager, the quality of service manager and the data exploitation manager are embedded in a programmable device.

14. The data processing hardware of claim 13, wherein the programmable device is a field programmable gate array.

15. The data processing hardware of claim 10, further comprising:
routing tables coupled with the quality of service manager for determining the routing of the data to a destination; and
a protocol engine coupled with the routing tables for specifying the protocol to be used in routing the data.

16. The data processing hardware of claim 9, further comprising an interface description language engine for receiving and changing the data from the security manager.

17. The data processing hardware of claim 13, further comprising a memory for storing a table of rules used to determine routing of the data at the platform.

18. The data processing hardware of claim 11, further comprising an XML parser coupled with the data exploitation manager for parsing data received at the platform in XML format.

19. A method of processing data received at a hardware platform forming a node in a data communication network, comprising the steps of:
(A) receiving data at the platform from the network;
(B) authenticating the data received in step (A) based on a predetermined security policy;
(C) detecting receipt at the platform of predetermined types of data; and
(D) passing only that data to a software application running on the platform that has been authenticated in step (B) and detected in step (C).

20. The method of claim 19, further comprising the step of:
(E) embedding the security policy in a circuit at the platform.

21. The method of claim 19, further comprising the steps of:
(E) embedding routing tables in a circuit at the platform; and,
(F) routing the data received in step (A) to a destination based on the routing tables embedded in step (E).

22. The method of claim 19, further comprising the step of:
(E) storing the security policy in a software application at the platform, and
wherein step (B) includes authorizing data received in step (A) to access a software application running on the platform based on the security policy stored in step (E).

23. The method of claim 19, further comprising the step of:
(E) prioritizing the data received in step (A) according to predetermined classes of data service.

24. The method of claim 23, further comprising the step of:
(F) embedding security protocols in a circuit at the platform that enforce the security policy.

25. The method of claim 19, further comprising the step of:
(E) prioritizing the data received in step (A) according to predetermined classes of data service.

26. The method of claim 25, further comprising the step of:
(F) embedding a quality of service manager in a circuit at the platform, and
wherein the quality of service manager performs the prioritizing in step (E).

27. The method of claim 19, further comprising the step of:
(E) embedding a data exploitation manager in a circuit at the platform, and
wherein the data exploitation manager performs the detecting of step (C).

28. The method of claim 19, wherein steps (B) and (C) are performed within a field programmable gate array.

29. The method of claim 19, including the step of:
(E) programming a circuit at the platform to perform steps (B) and (C).
